(19) United States
(12) Patent Application Publication
(10) Pub. No.: US 2016/0222274 A1
(43) Pub. Date: Aug. 4, 2016

(54) ADDITIVES FOR CONTROLLING LOST CIRCULATION AND METHODS OF MAKING AND USING SAME

(71) Applicant: SOLID FLUIDS & TECHNOLOGIES CORP., Calgary (CA)

(72) Inventor: TERRY HOSKINS, Calgary (CA)

(73) Assignee: SOLID FLUIDS & TECHNOLOGIES CORP., Calgary (CA)

(21) Appl. No.: 15/022,181

(22) PCT Filed: Sep. 12, 2014
(86) PCT No.: PCT/CA2014/050868

§ 371 Date: Mar. 15, 2016

Related U.S. Application Data
(60) Provisional application No. 61/878,513, filed on Sep. 16, 2013.
(60) Provisional application No. 61/938,972, filed on Feb. 12, 2014.

(51) Int. Cl. C09K 8/035; E21B 43/24; E21B 21/06; E21B 36/00; C09K 8/12; E21B 21/00

(52) U.S. Cl. CPC C09K 8/035; C09K 8/12; E21B 21/003; E21B 21/062; E21B 36/00; E21B 43/2406; C09K 2208/18

(57) ABSTRACT

The present invention relates generally to drilling and well servicing operations, particularly to additives comprising polystyrene to control lost circulation; drilling fluids comprising the additives; and methods of using same.

### FIELD OF THE INVENTION

The present invention relates generally to drilling and well servicing operations, particularly to additives comprising polystyrene to control lost circulation; drilling fluids comprising the additives; and methods of using same.

### BACKGROUND OF THE INVENTION

In the process of drilling a well into an oil and/or gas bearing formation, a drilling fluid or “mud” is pumped into the developing well bore through the drill pipe and exits through nozzles in the rotating drill bit mounted at the end of the drill pipe. The drilling fluid is circulated back to the surface through the annulus, the open space between the drill pipe and the wall of the well bore. At the surface, fluids are created, conditioned, or chemically treated if necessary. The drilling fluid system is typically designed as a loop with the drilling fluid continually circulating as the open hole is developed or conditioned.

Drilling fluid performs several functions essential to the successful completion of an oil or gas well and enhances the overall efficiency of the drilling operation. Drilling fluid is used, for instance, to cool and lubricate the rotating drilling tool, to reduce friction between the bit and the well bore, to prevent sticking of the drill pipe, to control subsurface pressure in the well bore, to lift the drill cuttings and carry them to the surface, and to clean the well bore and drilling tool of rock cutting and sloughing materials. Drilling fluid additives, such as lost circulation materials, lubricants, viscosifiers and the like, may be added to a drilling fluid to control or improve its properties.

Various types of drilling fluid are known including aqueous-, hydrocarbon-, or synthetic-based fluids; direct emulsions; invert emulsions; fresh, brine, or brackish water; or fluid containing inhibitors or salts. Gases may also be used (for example, air drilling or use of nitrogen to lower the density or create a foam of a base fluid). During the drilling operation, a portion of the drilling fluid may filter or flow into the permeable or fractured subterranean formation surrounding the well bore and is therefore not returned to the surface for recirculation. This lost portion is generally referred to as “lost circulation” which has a significant economic impact on the operation. Lost circulation, particularly of hydrocarbon-based drilling fluids, may negatively impact the environment. Lost circulation can occur at any time and depth in a drilling operation, and may occur in the form of two types of losses, namely fluid loss and seepage loss or total loss.

Fluid loss is encountered when a drilling fluid is forced against a medium through which it is able to filter. The solids in the drilling fluid (including all the solids added intentionally, drilled solids, polymers, and other drilling fluid products added to the base fluid) are filtered out of the base fluid by the medium (porous rock or formations), allowing the filtered base fluid to continue to pass through the filter cake that is formed by the solids and into the formations. Fluid loss may be reduced by varying amounts using correctly sized solids (usually in the <100 micron size) and additions of polymers. This allows the operator to control the thickness of the filter cake formed by fluid loss. If the filter cake is too thick, it can cause other well issues, while if the filter cake is too thin, it can cause lubricity or other problems.

Fluid loss of a fluid is typically measured under API (American Petroleum Institute) Procedures in either low pressure 100 psi/30 min fluid loss cells through a specifically sized filter paper to establish a rate and a quality of filter cake, or is run on a API HPHT Fluid Loss (high pressure high temperature) at 500 psi/30 min at either 50° C. or 65° C. depending on well type to establish a rate and quality (thickness) of the developed filter cake such that they can be controlled or tightened up to produce a better filter cake. However, although fluid loss may be controlled, seepage loss or total loss of drilling fluid may still occur.

Seepage or total fluid losses occur at areas of a formation known as loss or thief zones. Seepage losses occur when whole muds are lost to formations during drilling for example, when solids in the drilling fluid system are not large enough to serve as effective bridging agents for the porous or fractured formations. Mild to moderate seepage losses do not result in total loss of drilling mud to the formation; however, such losses significantly impact the cost of drilling. Total or severe fluid losses occur when whole fluids are lost to formations during drilling operations, and may be experienced in highly porous or fractured formations, such as fractured carbonates, and natural or mechanically induced fractures. Such losses are more defined where the porosity, fractures, karsting, or caverns are sufficiently large enough such that no filter cake can be formed because there is no medium or a reduced medium against which to filter. Whole mud volumes (including all the base fluid and its intentionally added chemicals) are subsequently lost to the formation.

The amount of whole drilling fluid loss depends on the structure and permeability of the formation being drilled. Seepage losses are generally expressed in a fluid volume of m³ or barrels per hour or over a set distance such as, for example, per 100 meters or feet. Total mud losses are generally expressed as m³ per hour or minute lost, or total m³ of drilling fluid volume lost. Generally drilling halts once total losses of drilling fluid are encountered. While it is possible to feed the well fluid with total losses and “drill blind” with no fluid returns to surface, this procedure confers many downsides and risks to the overall operation such as, for example, lacking control over the well in the event of a hydrocarbon influx.

Various additives or “lost circulation materials” (LCM) have been added to drilling fluids in attempt to control or prevent lost circulation to underground formations. LCM are pumped down the drill string to exit into or near the loss zone in order to plug the loss zone, or to build up a mat of material to decrease, seal off, or reduce lost circulation to the formations. Examples of common LCM include sawdust, wood fibers, plant cellulose, Gilsonite™ (uintaite or uintahite), asphalt, asphaltenes, plastics, cellophane, calcium carbonate, waxes, water soluble polymers, and thickening/gelling agents. LCM such as fibrous materials and calcium carbonate are used to control heavier seepage losses. LCM are often ground or blended to different particle sizes based on the expected severity of lost circulation.

However, LCM may permanently damage or plug the oil or gas bearing formation, damage the drilling fluid, and cause difficulties in maintaining the chemical or physical properties of the original drilling fluid. LCM that dissolve in the drilling fluid may alter the properties of the original fluid (for example, lubricity, viscosity or emulsion stability), which must then be corrected by additional measures. LCM can also cause mechanical problems in the drilling rig equipment, particularly the fluid pumps and solids control equipment, such as shakers, screens, and centrifuges.

Currently available solid additives have several disadvantages. Solids added to a hydrocarbon and water invert emulsion or direct emulsion can reduce the electrical or the emulsion stability of the drilling fluid. Calcium carbonates, particularly with a density of 2600 kg/m³, create higher densities in the hydrocarbon drilling fluid which can increase the rate of losses, and inverts can be lost by passing directly through these materials. Oil wetting chemicals must be added to ensure the solids are oil wet when drilling with a hydrocarbon based fluid. There may be slower rates of penetration from additional solids and higher plastic viscosities of the drilling fluid. Erosion of the deposited solids may occur with movement of the drill string and the annular velocity of the fluid pumping action.

If the losses occur near surface and in large volumes, control can be difficult as LCM can fill the voids but with the low hydrostatic pressure available from the fluid column and the low pressure fluid flow, LCM may not be compressed into a mat. The drilling fluids simply pass through LCM no matter how much material is applied to the lost circulation zone. If too much ineffective material is placed into the well bore without sealing the zone, additional drilling problems are created such as for example, tight hole conditions and the inability to move the pipe in what could potentially be a critical operation during drilling fluid losses.

In the event that losses are severe or do not respond to attempts to control them, and/or there are down hole restrictions, limitations in the pipe orifice openings, down hole solids screens, or in the drill string that limit the size or volumes of LCM, it is common to trip the drill string (i.e., cease operations and pull drill pipe) out of the hole and remove the tools or restrictions blocking the passage of the LCM. The drill pipe can then be run back in the hole so that LCM may be pumped down hole without restriction. It is also common to run back in the hole after the trip out to lay down all or some of the drilling tools, motors, directional tools, drill bits, or run in open ended with just drill pipe, so that cement, hydraulic or specialized cements, may be pumped from surface and placed down hole through the hollow drill pipe and exit the bottom into the open hole section to slowly harden, cure, or hydrate in an attempt to slow down or shut off losses of the drilling fluid. However, such operations of tripping in and out of the hole to remove tools, the LCM required, and the time lost drilling ahead and waiting for cement to harden, cure, or hydrate can greatly increase the overall cost of drilling a well.

### SUMMARY OF THE INVENTION

In accordance with a broad aspect of the present invention, there is provided an additive for a drilling fluid used in a drilling operation to control lost circulation, the additive comprising polystyrene.

In accordance with another broad aspect of the present invention, there is provided a drilling fluid comprising an additive to control lost circulation, the additive comprising polystyrene.

In accordance with another broad aspect of the present invention, there is provided a method of reducing or controlling lost circulation during a drilling operation comprising pumping a drilling fluid comprising an additive comprising polystyrene down hole during the drilling operation.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE FIGURES

Referring to the drawings, several aspects of the present invention are illustrated by way of example, and not by way of limitation, in detail in the figures, wherein:

FIG. 1 is a schematic illustration of one embodiment of a fluid loss control additive comprising a polystyrene particle coated with a surfactant.

FIG. 2 is a schematic illustration of one embodiment of a fluid loss control additive comprising an expanded polystyrene particle coated with a surfactant.

FIG. 3 is a graph comparing the filtrate volume (mL) over time expressed as square root (min^{1/2}) for Gilsonite™ and the additive of the present invention.

FIG. 4 is a graph comparing the filtrate volume (mL) over time expressed as square root (min^{1/2}) for Gilsonite™, Gilsonite™+Fibre Fluid M™, and the additive of the present invention.

FIG. 5 is a graph comparing the filtrate volume (mL) over time expressed as square root (min^{1/2}) for the additive of the present invention and LCM mixture.

FIG. 6 is a graph comparing the filtrate volume (mL) over time expressed as square root (min^{1/2}) for the additive of the present invention and LCM mixture.

### DETAILED DESCRIPTION

The detailed description set forth below is intended as a description of the present invention and is not intended to represent the only embodiments contemplated by the inventor. The detailed description includes specific details for the purposes of providing a comprehensive understanding of the present invention. However, it will be apparent to those skilled in the art that the present invention may be practiced without these specific details.

The present invention relates generally to drilling and well servicing operations, particularly to additives comprising polystyrene, to control lost circulation; drilling fluids comprising the additives; and methods of using same. As used herein, the term “lost circulation” refers to a lost portion of drilling fluid which may filter or flow into a permeable or subterranean formation surrounding a well bore and is therefore not returned to the surface for recirculation. The term includes drill fluid loss, and seepage losses or whole losses. As used herein, the term “drill fluid loss” refers to loss of the base fluid through a filtered medium. As used herein, the term “seepage losses” refers to gradual loss of whole mud through larger porosity without filter cake formation. As used herein, the term “whole losses” refers to large volume losses of all fluids to any formation such as, for example, a fracture.

Accordingly, in one embodiment, the additive comprises polystyrene, and optionally, a performance enhancer. As used herein, the term “polystyrene” refers to a synthetic aromatic polymer made from the monomer styrene, or poly(l-phenylethane-1,2-diyl). Polystyrene can be rigid or foamed. The term is meant to include various forms of polystyrene including, but not limited to, polystyrene particles, ground crystal polystyrene, or expanded polystyrene (i.e., closed cell foam made of pre-expanded polystyrene beads). The polystyrene may be newly manufactured or preferably recycled.

As used herein, the term “performance enhancer” broadly refers to a surfactant or surface active agent which may be any compound that reduces surface tension when dissolved or suspended in water/water solutions, or which reduces interfacial tension between two liquids, or between a liquid and a solid, and consists of three categories (i.e., detergents, wetting agents, and emulsifiers). A surfactant or surface active agent may be anionic, cationic, non-ionic, and/or amphoteric. In one embodiment, the performance enhancer comprises a surface active agent, a surface tension reducer, or a wetting agent. The performance enhancer facilitates the mixing of polystyrene into aqueous-based drilling fluids, and contributes to the overall performance of the additive for example, by enhancing dispersion, emulsion or suspension stability, and storage capability. The performance enhancer is not required in the event that ground crystal polystyrene is mixed into a refined hydrocarbon-based drilling fluid (excluding diesel fuel). Refined hydrocarbon-based drilling fluids are those which lack BTEX components (i.e., benzene, toluene, ethylbenzene, and xylenes), have higher flash points, and fewer aromatics.

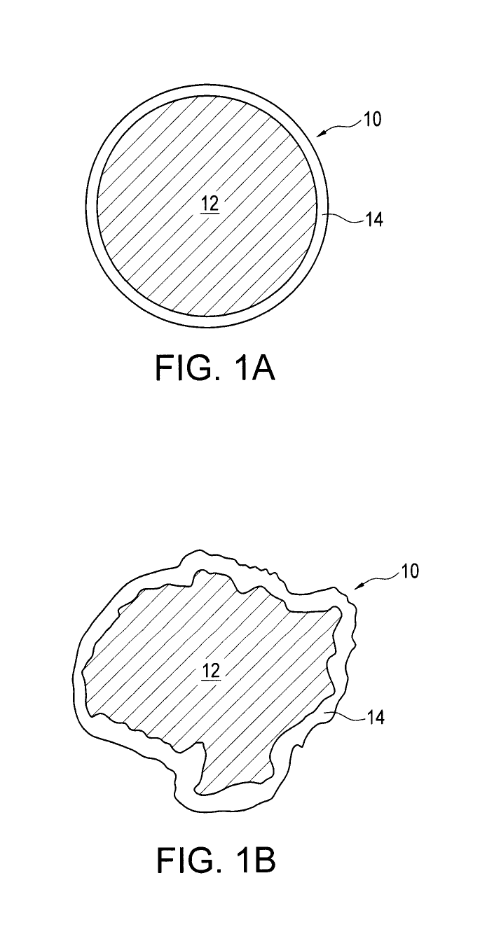

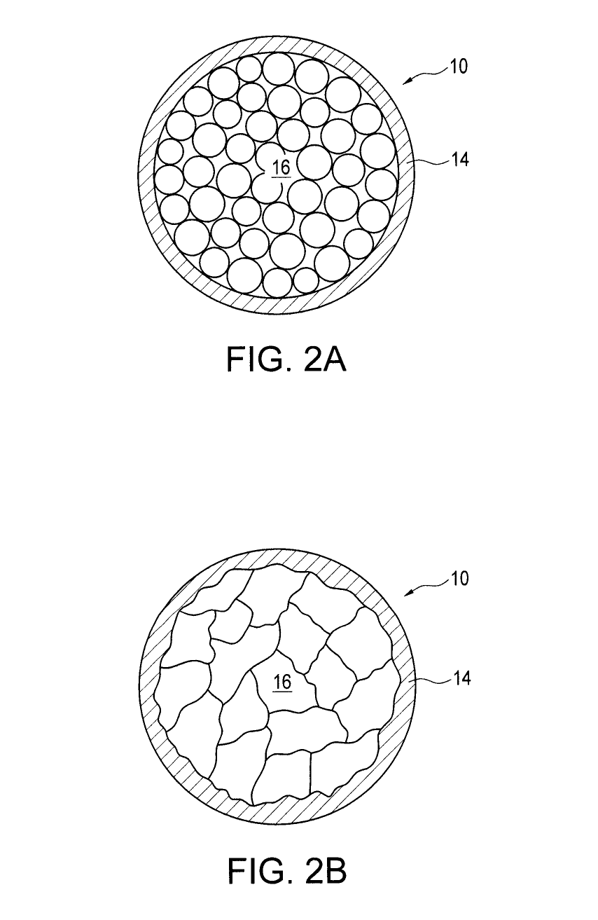

The performance enhancer can be utilized to water wet expanded polystyrene and provide the benefit of being a defoamer in the formed suspension. With reference to FIG. 1, there are shown additives 10 comprising polystyrene in the form of particles 12 coated with performance enhancers 14 such as, for example, surfactants. FIG. 2 shows additives 10 comprising expanded polystyrene in the form of particles 16 coated with performance enhancers 14 such as, for example, surfactants.

The additive may be prepared by any suitable means known to those skilled in the art. A performance enhancer may be added to polystyrene for example, by blending or coating using techniques including, but not limited to, soaking and drying, spray-coating, and the like. The performance enhancer may be added directly to a drilling fluid before, during, or after additions of the expanded polystyrene.

In one embodiment, the additive of polystyrene may comprise particles. It is contemplated that the shape, size (diameter), and number (density) of the particles may vary. It will be appreciated by those skilled in the art that the particles may be round, spherical, irregular, pellets, flakes, slivers, sheets, chunks, or chips. As used herein, the term “micron” may be used to refer to any dimension of the particle. The term “diameter” may be replaced with width, length, cross-section or the like without losing sight of the overall intended size of the particle. For example, a flake may have a width of about 400 microns and it would be understood then that the length could be larger or smaller and the depth smaller than this number.

The particles may have either uniform or varying sizes. Smaller particles are able to access tight spaces in the formation, and gaps between the drilling tool and the formation. If particles are sufficiently small, they will also enter and plug the pores in the formation to control fluid and seepage losses. Larger particles remain in the well bore and are less likely to enter small pores and fractures in the formation. However, larger particles may be mechanically applied or smeared onto the well bore wall through the action of the tubulars during rotation or reciprocation and cover or bridge multiple pore sites or minor fractures.

The additive may comprise particles of any suitable size. In one embodiment, the additive comprises polystyrene with a particle size ranging from about 1 micron to about 30,000 microns, preferably from about 500 to about 20,000 microns, more preferably from about 1000 microns to about 10,000 microns, and most preferably from about 1000 microns to about 5,000 microns. In one embodiment, the particle size ranges from about 400 microns to about 3,000 microns. In one embodiment, the particle size ranges from about 50 microns to about 750 microns.

Polystyrene may be ground down to relatively small particles sizes which may be beneficial for controlling lost circulation. In one embodiment, the particle size ranges from about 5 microns to about 10 microns. In one embodiment, the polystyrene has a particle size of at least about 45 microns. In one embodiment, the expanded polystyrene has a particle size of at least about 250 microns.

In choosing a suitable particle size range for the additive, any lower limit (e.g. 1, 50, 100, 300, 500, 1000 etc., microns) may be combined with any upper limit (e.g. 100, 1000, 5000, 10000, 20000, 30000, etc., microns). A blend may comprise particles from various size ranges, for example, 50% of particles may in the 100-1000 micron range and 50% particles in the 1000-5000 micron range. In one embodiment, 50% of the particles are in the 50-500 micron range for controlling total fluid losses and 50% of the particles are in the 100-1000 range for controlling seepage losses. The distribution could be 33.3% and 66.7% or any other suitable distribution. In one embodiment, ⅓ of the particles are in the 200-500 micron range for controlling fluid losses, ⅓ of the particles are in the 1000-3000 range for controlling seepage losses, and ⅓ of the particles are in the 5000-30000 micron range for controlling severe losses.

In one embodiment, the blend comprises particles from various size ranges of polystyrene, expanded polystyrene, and combinations thereof. Unlike fibrous materials or organic material, the components of the blend may be relatively sterile or contain minimal contaminants. The drilling fluid thus lasts longer, does not require the addition of bactericide and is environmentally friendly and relatively inexpensive.

To formulate a blend, any lower limit may be combined with any upper limit to define an unlimited number of particle size ranges. The distribution may be defined as a percentage or a ratio. A ratio or volume may be expressed by weight, volume or number of particles. Ratios and percentages are preferably expressed by weight.

In one embodiment, the blend comprises expanded polystyrene having a specific gravity ranging from about 10 kg/m³ to about 350 kg/m³. The desired specific gravity can be achieved by expelling air from the closed cells of the expanded polystyrene using suitable techniques such as for example, mechanical pressure. A blend having high density remains suspended for a longer duration in a drilling fluid compared to a blend having a low density suspended in the same fluid. In addition, the particle size is a factor in the suspension. Compared to larger particles, smaller expanded polystyrene beads require less viscosity or suspension characteristics in the drilling fluid to be suspended, and can be suspended over a much longer time period in a drilling fluid. The expanded polystyrene rises over time to the top of the drilling fluid due to buoyancy. A material which can float to the top of the drilling fluid when permeating pore spaces, fractures, permeability, karsting, voids or other open areas enables the building of a mat of material from the top down. Conventional LCMs are heavier than water or close to water densities and cannot achieve this result. Such LCMs enter the well bore and spread out on the bottom of the loss zones or formation, allowing the drilling fluid to flow over the LCMs while building a mat from bottom to top.

The viscosity of the drilling fluid also affects the suspension of the additive. Suspension characteristics of a drilling fluid (for example, fluid yield point and gel strength) can be increased with additives to gel and viscosify the drilling fluid, thereby lengthening the suspension time of additives within the drilling fluid. A low density water based drilling fluid can be used to drill formations that are under-pressured or subject to overbalanced fracture formation or hydrostatic pressure induced losses to formation of the drilling fluid. The drilling fluid may be formed with its effective density or equivalent circulation density greatly reduced by expanded polystyrene beads suspended therein. A portion of the volume per unit of volume becomes a percentage of suspended expanded polystyrene beads, each containing in the range of about 1% to about 98% of air in closed cells contained within the bead. As the beads displace a percentage of volume from the drilling fluid, the effective density decreases as a portion of the fluid is displaced. The effective density of a drilling fluid can be greatly reduced with a suspension, temporary suspension, or partial suspension of expanded polystyrene beads in a viscosified fluid. In one embodiment, the beads for forming a low density drilling fluid may have sizes ranging from about 0.1 mm to about 6 mm. In one embodiment, the beads have sizes ranging from about 0.1 mm to about 1.0 mm. Once a suspension formed of the beads or a low density drilling fluid including the beads has been formed, even larger sizes of beads can be suspended for longer times within the same formed suspension. A low density water based drilling fluid may be prepared with expanded polystyrene beads in a viscosified fluid to lower the density, effective density, or bulk density of the drilling fluid by as much as about 75%, while still providing a pumpable fluid for use with a centrifugal pump and/or centrifugal pre-charge pump connected to another kind of fluid pump.

Centrifugal pumps have difficulty pumping foamed or foamy fluids as the pumps will cavitate if air is present in a fluid. The air in the low density drilling fluid comprising expanded polystyrene beads is contained inside the closed cells of the polystyrene casing. The centrifugal pump treats the expanded polystyrene as a solid (although slightly compressible material) within the fluid and will not cavitate unlike other low density foamed fluids. It is desirable to use fluid having a density less than water for many drilling or work over operations. The reduced density provides less hydrostatic head on the fluid column, allowing operators to balance the fluid to formation pressures or control at, near, or below formation pressures to avoid pushing, flowing, fracturing, or forcing the fluids into a formation or zone.

Water wetting promotes matting of the materials or product drop from the drilling fluid to build a better bridge of self-adhering particles in non-surface wetted clusters. The drilling fluid may be treated with a surfactant to water wet the expanded polystyrene beads for better suspension in a drilling fluid. Alternatively, the expanded polystyrene beads can be added to the drilling fluid and allowed to water wet during mechanical agitation over time and mixing of the drilling fluid.

The additive may increase rate of penetration (ROP) in a drilling operation, decrease wear on the drilling tool, result in less downtime in the operation, reinforce hole stability, and facilitate additive removability or solubility. The additive may decrease the density of a drilling fluid and reduce hydrostatic pressures. The additive can be used to replace other higher gravity solid LCM materials (for example, calcium carbonate), and reduce contamination of a drilling fluid due to such solids. Fine screens or high gravity centrifuges have been used to remove drilled solids and/or undesirable drilled solids from the drilling fluid to maintain or reduce the drilling fluid density as low as desired. Similarly, solids control screens may be used to filter out the low density expanded polystyrene beads from the drilling fluid. The expanded polystyrene beads can thus be separated from unwanted drill solids and returned back into clean drilling fluid for re-use. A pressurized water spray can be directed over the solids control shaker screens and angled so as to move the low density expanded polystyrene beads and flakes over to one side of the vibrating screen assembly and over a ramp that forces the material back into the cleaned drilling fluid cycle for reuse.

Solids processing or removal centrifuges may also be used to removed drill solids or cuttings from the low density drilling fluid comprising expanded polystyrene beads by flowing the drilling fluid which is moving back up the annulus or well bore to surface into a settling tank. In the tank, drill solids that are heavier than the low density drilling fluid drop to the bottom of the holding tank, and separate by gravity. Centrifuges can also be aligned to grab suction from the bottom of the settling tank to remove the solids from the tank in a drier form for disposal, and from the top of the settling tank. The centrifuges may process the lighter fluid, remove heavier drill solids, and send the lighter expanded polystyrene materials and fluid back into the active system or drilling fluid to be reused and sent back into the circulation loop of the drilling fluid system.

The porosity and permeability of an underground formation and microfractures in a substantially non-permeable formation should be considered when selecting an appropriate particle size range for the additive. Porosity may be measured in microns and permeability may be measured in darcys. A darcy is a measure of flow through a channel and provides a connection to porosity measurements in a formation. Seepage losses are generally experienced in porous formations having a permeability of greater than about 300 darcys and in fractured formations. Fractures vary in size for example, from 100 microns in diameter to very large cracks.

In selecting an appropriate particle size, consideration should be given to the ratio of the size of the particles in the drilling fluid to the pore size of the rock being drilled. During drilling, a constant flow of whole mud into a formation is commonly experienced. The formations to which whole mud can be lost include for example, cavernous and open-fissured formations, very coarse and permeable shallow formations such as loose gravel, natural or intrinsic fractured formations, and easily fractured formations. In general, when the ratio of particle size to pore size is less than about 1/3, whole mud passes through the formation, bridging does not occur, and seepage or total losses are experienced. For example, if the pore size of a formation is 90 microns and the particle size is 25 microns, whole mud loss occurs.

The malleability or deformability of the additive allows its mixing with a drilling fluid and its formation into a barrier layer which reduces or controls lost circulation, even at low pressures and fluid flow. Various types of drilling fluid are known including aqueous- or hydrocarbon-based fluids, water-in-oil or an oil-in water (“invert”) emulsions, or a well kill fluid formed of regular drilling fluid weighted up with barite, hematite or other solids to confer sufficient density to produce a hydrostatic pressure which substantially shuts off flow into a well from an underground formation. The additive may also be added to a completion brine or other well treatment fluid.

Preferably, the drilling fluid includes only the additive, since there is a need in the industry to reduce the number and amount of additives which must be used in order to successfully complete an operation. A single, effective additive is economical and simple to prepare and use.

Optionally, the drilling fluid may include the additive in combination with one or more other components including, but not limited to, polyurethane, lost circulation materials (“LCM”), liquid or solid lubricating agents, other additives, inhibitors, or combinations thereof. Suitable LCM include, but are not limited to, organic fibers, cellulose, sawdusts, Gilsonite™ (uintaite or uintahite), asphalt, cellophane, plastics, calcium carbonate, sulfonated asphalt, sulfonated gilsonite, waxes, or combinations thereof. In one embodiment, the LCM comprises cellulose. The LCM may be in the form of shavings (e.g., a few millimeters) or chunks (e.g., similar in size to sugar-cubes) while drilling with a bottom hole assembly.

Other additives for drilling fluids fall into several basic groups including, but not limited to, viscosifiers, such as natural or treated bentonite, mixed metal hydroxide (MMH), mixed metal oxide (MMO), guars or polymers, Bentone™ 150 or Baragel™ 3000 (organically modified bentonite clay); weighting agents, such as barite or calcium carbonate; surface active agents; emulsifiers, i.e. a “primary” oil mud emulsifier such as a blend of stabilized fatty acids in liquid form, that reacts with lime to form a soap-based emulsifier, a “secondary” oil mud emulsifier such as a sulfonated amino amine, blended with wetting agents to be used as a co-emulsifier; oil wetters; alkalinity control additives; fluid loss reducers, such as Drispac™ Poly-anionic Cellulose (PAC) or Drillstar™-Yellow; thinners or dispersants; flocculants; defoamers; lubricants; shale inhibitors, such as calcium chloride or amines; corrosion inhibitors and anti accretion agents which reduce or eliminate the potential for raw bitumen oils to build up on the drilling components, rig, or metal surfaces.

The additive of the present invention may be added to a base fluid or added directly to a drilling fluid. As used herein, the term “base fluid” refers to an aqueous- or hydrocarbon-based fluid or an emulsion of either. The additive may also be dispersed or suspended in a suitable carrier liquid prior to being added to the base fluid or the drilling fluid. The additive may be added to the base fluid or the drilling fluid before or following the addition of one or more of the above components.

The additive of the invention may be added to a water based fluid that is thixotropic. As used herein, the term “thixotropic” refers to the property exhibited by a viscous fluid becoming liquid when stirred or shaken.

The additive of the invention may be added to a water based fluid that contains or achieves viscosity or thixotropy from one or more cross-linked polymers or MMH, MMO, and/or other mixed metal materials, and bentonite or treated bentonite materials added to a drilling fluid.

The additive may be present in the drilling fluid in an amount ranging from about 0.01 kg/m³ to about 500 kg/m³. The volume may be measured before the additive is added, for example, about 0.01 kg to about 500 kg may be added to 1 m³ of drilling fluid. The amount of additive and rate of its addition to the drilling fluid depend on the expected characteristics of the formation or “real-time” lost circulation experienced at a particular location in a formation. It is contemplated that one skilled in the art would recognize the appropriate amount of additive and a suitable addition regimen for any given drilling operation and formation.

In one embodiment, the amount of the additive in a drilling fluid ranges from about 0.01 kg/m³ to about 200 kg/m³, preferably from about 0.01 kg/m³ to about 100 kg/m³, more preferably from about 0.01 kg/m³ to about 50 kg/m³, and most preferably from about 5 kg/m³ to about 20 kg/m³. In one embodiment, an amount of less than 50 kg/m³ is preferred due to minimal effects on the drilling fluid or the drilling operation.

The additives of any of the embodiments may be included in a kit. The additive may be diluted with a drilling fluid to a predetermined concentration. The kit may be in the form of a bag or tote which is sufficiently sized to hold a mixture of the polystyrene, and optionally, the performance enhancer. The additive may thus be premixed or blended, and stabilized such that the additive may be stored at a warehouse or on location, and is readily available for quick addition to the drilling fluid as required. In one embodiment, there is provided a kit comprising polystyrene; and optionally, a performance enhancer. In one embodiment, there is provided a kit comprising polystyrene; optionally, a performance enhancer; and one or more lost circulation materials. In one embodiment, the lost circulation materials comprise cellulose.

In the field, the additive is not necessarily added based on a typical concentration range, given the particle sizes being used. Some of the additive (depending on particle size) does not stay in the system, and is either placed in a particular zone as desired or removed by solids control on return to the surface. Amounts of the additive may be added in a constant, steady manner while drilling ahead, although an initial amount of the additive may be dispersed in a base fluid or drilling fluid prior to drilling. In one embodiment, the additive may be added in units of sacks per 100 meters drilled. Additional larger pill volumes may also be added during the drilling operation as needed.

In one embodiment, the additive may be heated to a temperature above its glass transition temperature. As used herein, the term “glass transition temperature” refers to the temperature at which a material reversibly transitions from a solid (i.e., hard, rigid, relatively brittle state) into a molten or rubber-like state. Polystyrene exists as a solid at room temperature, but flows if heated above its glass transition temperature of about 100-110° C. It becomes rigid again upon cooling. When heated accordingly, polystyrene can move further into porosity as a very viscous fluid creating a much more effective seal in the porosity. Expanded polystyrene refers to closed cell foam made of pre-expanded polystyrene beads. When expanded polystyrene is heated above its glass transition temperature of about 100-110° C., it becomes softer and able to flow, releasing air and reducing in size even after the temperature is reduced. The size reduction may be as high as 95%. Such reduction in size facilitates removal of the materials upon hydrocarbon production from pores, porosity, permeability or tight spaces in the formation.

The additive of the present invention may be used with a variety of mud systems including but not limited to, (1) inverts, which are hydrocarbon based and require complete offsite disposal of cuttings and reconditioning of the mud system, which is very costly but effective in highly unstable well bores; (2) potassium chloride (KCl) or potassium sulfate systems, which are water based systems that provide effective shale inhibition via ion exchange in the shales, but require costly disposal of not only the cuttings but also the system due to high chloride content; (3) silicate systems, which are water based and effective but require costly disposal of solids and have other associated problems; (4) amine systems, which are water based and fairly effective compared to KCl systems, however are fully disposable on the drilling site or surrounding land, so are more cost effective than the KCl systems; (5) polyacrylamide or PHPA systems, which are more of an encapsulation type of inhibition for shales and are fully disposable; and (6) normal water based systems in which there are no inhibitors (just bentonite and polymers) which are fully disposable. The drilling fluid system may also be designed to prevent the accretion of bitumen or raw hydrocarbons from building up on the drilling equipment or pipe; for example, such as in a drilling fluid designed to drill heavy oil wells like SAGD wells or well into heavy oil or bitumen bearing formations. The drilling fluid system may also be a system formulated to exhibit thixotropy such as an MMH or MMO fluid.

The additive of the present invention is suitable for various drilling procedures including horizontal, vertical or directional drilling; heavy oil drilling; SAGD; drilling under difficult hole conditions; or offshore drilling, provided that the additive and drilling fluid meets strict toxicity standards.

The additive of the present invention is not an environmental hazard and passes micro toxicity testing at very high threshold levels.

Accordingly, in one embodiment, the present invention relates to a method of reducing or controlling lost circulation during a drilling operation. The method generally involves pumping a drilling fluid comprising the additive down hole during the drilling operation.

In one embodiment, the additive can be removed partially or completely with an additional well treatment upon completion of the well by using a wash of a suitable solvent including, but not limited to, an aromatic hydrocarbon (for example, benzene, toluene, xylene, ethylbenzene), a chlorinated aliphatic hydrocarbon (for example, methylene chloride, chloroform, carbon tetrachloride), or other solvent (diesel, d-limonene, pyridine, acetone, dioxane, dimethylformamide, methyl ethyl ketone, diisopropyl ketone, cyclohexanone, tetrahydrofuran, n-butyl phthalate, methyl phthalate, ethyl phthalate, tetrahydrofurfuryl alcohol, ethyl acetate, butyl acetate, 1-nitro-propane, carbon disulfide, tributyl phosphate, cyclohexane, methylcyclohexane and ethylcyclohexane) to dissolve and/or break down the polystyrene of the additive.

In one embodiment, the additive can be removed partially or completely by steam vapor such as that produced for example, in a SAGD process, or by heating a heavy oil or bitumen formation. Alternately, a known solvent of polystyrene may be added to the steam generated for a SAGD steaming process to additionally remove any polystyrene in the formation. The additive may be heated to a temperature above its glass transition temperature to transition from a solid (i.e., hard, rigid, relatively brittle state) into a molten or rubber-like state. Polystyrene exists as a solid at room temperature, but flows if heated above its glass transition temperature of about 100-110° C. Expanded polystyrene refers to closed cell foam made of pre-expanded polystyrene beads. When expanded polystyrene is heated above 100° C., it becomes softer and flowable, releasing air from within the closed cells, thereby collapsing to reduce in size by as much as 95% or more, or in accordance to the amount of air contained in the expanded polystyrene being used. Such reduction in size facilitates unplugging of the additive from within the porous formation and fractures. The additive in the form of unimpaired small solids is removed with produced fluids. Removal of the additive by steam vapor is preferable over washing with solvents. The operator can simply apply steam to the desired zone to heat the expanded polystyrene beyond its glass transition temperature to achieve its transition into a flowable, removal material. Such a method reduces the need to use hazardous, expensive solvents.

In one embodiment, the additive can be utilized to control fluid loss or seepage loss to a formation by plugging near well bore porosity and/or permeability by becoming part of the applied filter cake of solids. As drilling fluid temperatures increase due to circulation or by penetration to deeper depths, the additive heats up, reaching its glass transition temperature and phase, and proceeding further into the well bore porosity and/or permeability as a fluid rather than solid particles. Subsequently, the additive further seals the porosity and/or permeability in the form of a very viscous, hard to flow fluid.

In one embodiment, the additive can be combined with a drilling fluid to yield a very low density suspension of expanded polystyrene or a “compressible” drilling fluid. A compressible drilling fluid formed from compressible expanded polystyrene materials and non-compressible fluids (e.g., water) or partially compressible fluids (e.g., hydrocarbons), is desirable. The materials can be deformed under pressure to a smaller form and pumped through the circulation system or drilling fluid loop. As the materials are circulated past, though, or by a loss zone, zone of low pressure, or lower pressure, the expanded polystyrene materials will move into the low pressure zone. Due to the resiliency of the closed air cells in the expanded polystyrene, the materials start to increase or expand back to a larger than compressed size or close back to the original size if the pressure drop is sufficiently low. This can be useful in controlling losses to a zone or formation by compressing the solid expanded polystyrene closed cell air bubbles, and allowing them to move into a lower pressure area, re-expand and close off the porosity or permeability into which the expanded polystyrene entered at it smaller size. This pressure transition of the material (i.e., the transitional effects of the particle under compression moving from a high pressure area to a lower pressure area and re-expanding in size based on the particle resiliency and Boyles Law) in the zone can be used to seal off the zone. A very low density drilling fluid (having a density less than the base fluid and including suspended expanded polystyrene) that is compressible, and can pass from an area of high pressure to lower pressure to uncompress is highly desirable to the industry. It may reduce costs from whole fluid losses, and negative impacts on the environment due to its reduced disposal, carbon footprint, and equipment and energy inputs to the well. Further, this non-damaging drilling fluid has the ability to remove the expanded polystyrene materials from a hydrocarbon producing well by multiple methods including, but not limited to, use of solvents, modifications in temperature, and exposure to the unrefined hydrocarbon production fluid acting as a solvent on the expanded polystyrene. The expanded polystyrene can be returned to production facilities for removal.

The additive may be added at any stage in the formulation of the drilling mud by methods known to those skilled in the art.

The method may be used for prevention or treatment, or a combination thereof. For prevention to control or reduce lost circulation throughout the entire drilling operation, the additive can be added to the base fluid and/or drilling fluid before drilling or being pumped down the well. This is especially useful in cases where high seepage losses are anticipated prior to drilling. For treatment, the additive is added to the drilling fluid while drilling ahead, particularly when lost circulation is experienced or anticipated at particular locations in the formation. The additive may be added as a single dose prior to drilling or may be added in discrete doses, or continuously, throughout the operation. The additive may be added slowly while drilling ahead and/or in heavy sweeps and pill additions.

Typically, an initial volume of fluid additive is added to the base fluid and/or drilling fluid before drilling, or being pumped down the well, and additional volumes are added throughout the drilling operation as needed. The amount of additive in the drilling fluid may be adjusted throughout the operation to account for any sudden changes in lost circulation that are experienced.

In the event of anticipated or “real-time” surges in lost circulation, pill volumes of the additive are added to the drilling fluid and pumped down hole. A pill volume is a discrete high concentration of additive that is added to the drilling fluid.

In one embodiment, the additive is continually mixed into the drilling fluid. Higher volumes of the additive or higher rates of addition are generally used to counteract higher seepage losses or higher drag and torque. The rate and route of addition can be adjusted throughout the operation to account for changes anticipated or encountered.

The additive may be mixed directly into the active circulating drilling fluid at a rate of about 0.01 kg to about 100 kg per minute while drilling ahead. The additive may be added at a concentration ranging from about 50 kg to about 200 kg per 100 m of new hole drilled during the drilling operation. The additive/drilling fluid can be “spotted” into a particular place in the hole where needed or circulated into the hole through the circulating system. By “spotted,” it is generally meant that the drilling fluid is delivered directly to a desired area of the well bore or formation, where lost circulation is anticipated or experienced. The additive may also be suspended or dispersed in a carrier fluid or base fluid and added directly into the hole.

For seepage losses, the additive being sufficiently small to pass through the solids control measures (designed to remove undesirable solids or drill solids) may be added to the drilling fluid, such that a concentration of the additive is carried within the drilling system to control fluid loss. The further addition of larger additive over a given distance of well may provide seepage loss control per 100 meters. To alleviate total loss of part of the drilling fluid system, the additive may be rapidly added as needed (kg per min or hour).

Without being bound by theory, the additive reduces the overall density or specific gravity of the drilling fluid. Reduction of the density of the drilling fluid (for example, by up to 40%) translates into less active volumes to build; less trucking of fluids; less volumes to dispose of at the end of the well or project; lower fluid costs of all the products required to build the drilling fluid; reduced applied hydraulics while still protecting fluid yield and carry capacity; drastically reduced seepage or fluid losses while drilling; reduced formation damages as the additives are removable with steam; and less overall greenhouse gas emissions for the operation. Polystyrene has a very low specific gravity. When added to the drilling fluid, the additive displaces volume from the drilling fluid to occupy space, thereby lowering the overall density of the combined fluids to a lower specific gravity and equivalent circulating density (ECD). As the specific gravity of the base fluid decreases, the potential for losses under a lower hydrostatic pressure exerted by the fluid column reduces the potential for losses and the volume of losses. The additive is easily mixed into the drilling fluid and requires very little hydrostatic pressure or fluid movement between the particles to compress them and start to build a layer or mat to slow the loss of drilling fluid, and subsequently initiate the plugging process. The additive is easily removable and functions at shallow depths in severe lost circulation scenarios.

Larger sized expanded polystyrene materials provide several benefits as unconventional LCM. Larger sized expanded polystyrene materials are ideal to rebuild internal zone and lattice structures in depleted zones or voids. The ultralow densities of expanded polystyrene allow for large amounts of this LCM to be added to a drilling fluid creating ultralow density pills. Expanded polystyrene compressibility can also improve placement into loss zones during pressure transition. Expanded polystyrene low density materials are easily carried by drilling fluids into a formation to create a seal. In horizontal well bores where fluid contact with the upper circumference of the loss zone may be minimal, these low density materials can be engineered to release and float in the fluid. This vertical movement or buoyancy of expanded polystyrene can help bridge the upper circumference of the well bore and formation. The opposite of this effect may be described as when higher density LCM pills or cements settle out broadly into the loss zone without completely sealing the upper circumference of the well loss zone. Expanded polystyrene creates a LCM fluid that can effectively work from the top of a loss zone filling in down to the bottom of the loss in an unconventional manner. Conventionally LCM would drop out of a LCM fluid, due to higher densities, and try to create a bridge or matt of material in a loss zone from the bottom up.

The above-described embodiments of the invention are intended to be examples only. Alterations, modifications and variations can be effected to the particular embodiments by those of skill in the art without departing from the scope of the invention, which is defined solely by the claims appended hereto.

Exemplary embodiments of the present invention are described in the following Example, which is set forth to aid in the understanding of the invention, and should not be construed to limit in any way the scope of the invention as defined in the claims which follow thereafter.

### Example 1

The ability of the additive of the present invention to control or reduce lost circulation to a highly permeable or porous rock formation was tested using a test cell which simulated a closed loop circulation system of a drilling fluid through a porous rock structure. The test cell allowed the process to be visualized through a clear flow chamber, and the application of fluid pressure up to 50 psi upon the cell itself and any formed seal of the porosity inside the flow chamber after the application of the test samples which were polystyrene alone; polystyrene with cellulose; and polystyrene and polyurethane foam.

The test cell was constructed from 3 inch acrylic plastic and 3 inch PVC pipe components bonded and threaded together, and included fittings to allow the circulation of fluids through the test cell in a continuous loop. The test cell was provided with a threaded opening at one end of the test cell to allow the insertion and sealing of the porous rocks within the loop. The test cell was oriented horizontally to rest on top of a table. A holding tank in the form of a plastic bucket was used to store either fresh water or the drilling fluid. A centrifugal pump was placed within the holding tank to circulate the fresh water or drilling fluid through the test cell.

“Tufa rock” was used to simulate a carbonate underground formation susceptible to drilling fluid loss. Tufa rock shares a similar composition, structure, and surface texture to the Grossmont formation (Northern Alberta, Canada) which is a heavy oil bitumen producing zone of very high permeability and porosity. The formation has fractures and karsting and a fluid flow that is severely under-pressured, resulting in severe to total losses of drilling fluids. Tufa rock was placed inside the chamber so as to allow large vugular, porous spaces.

Fresh water was circulated through the test cell to ensure unrestricted circulation of a fluid. The test cell was then fully drained so as not to contaminate the drilling fluid.

A drilling fluid was prepared with the proper chemistry to support a drilling fluid suitable for drilling the Grossmont heavy oil formation and prevention of bitumen accretion on metals. The drilling fluid was treated with 2 L/m³ of SuperWet™ wetting agent such that the polystyrene and polyurethane foams could be easily dispersed into and throughout the drilling fluid. The drilling fluid (10 L) was placed into a holding tank and circulated using a centrifugal pump through the test cell and tufa rock. After a circulation rate was established with drilling fluid, a slightly lower rate than water (as expected due to the increased viscosity of the drilling fluid) was achieved.

The test samples (polystyrene alone; polystyrene with cellulose; and polystyrene and polyurethane foam) were introduced after several loop circulations of the drilling fluid. Various particle sizes of virgin polystyrene, expanded polystyrene, closed cell, and open cell polystyrene, and polyurethane foams were prepared, in addition to coarsely ground cellulose fiber (% Thru 4 mesh 100%, % Thru 20 mesh 97%, % Thru 60 mesh 75%, % Thru 80 mesh 50%, % Thru 100 mesh 35%, % Thru 140 mesh 30%, % Thru 200 mesh 10%), and introduced to a 5% loading by volume into the drilling fluid and circulated until the tufa rock was plugged with the materials and no further circulation was possible.

After holding pressure on the seal with the centrifugal pump for 2-3 minutes, a secondary line was disconnected and water pressure was applied to the test cell in the direction of the flow loop to 50 psi. This extra pressure helped form the seal which was able to withstand the pressure such that the polystyrene was not forced past the rock face and further into the large porous voids further along the test cell which would cause lost circulation.

The addition of the 5% loading was able to seal the rock face and a few inches into the tufa rock formation within a few seconds. The addition of 50 psi of water pressure confirmed that the seal could hold this increased pressure and that no further fluid moved past the newly formed seal.

### Example 2

Potential use of the additive of the present invention (1 mm expanded polystyrene beads (EPS)) in an oil based drilling fluid was determined by testing the additive over a range of temperatures (65° C., 100° C.) and through various filtration media. A basic invert emulsion drilling fluid formulation was used as the medium for testing the additive against a commercial additive known as Gilsonite™ (uintaite or uintahite) which is a form of natural asphalt found only in the Uintah Basin of Utah. The test samples (350 mL) were prepared by first combining the components in the order set out in Table 1 in a 500 mL hot rolling cell and mixing at very high shear for 5 minutes using a homogenizer type mixer.

TABLE 1

| Component | Concentration | |
|---|---|---|
| Base fluid (Cutter D) | 90:10 oil:water ratio (“OWR”) | |
| Lime | 7.5 | kg/m³ |
| Organophilic Clay | 15.0 | kg/m³ |
| Primary Emulsifier | 8.0 | L/m³ |

An amount of 30% CaCl₂ brine was then added as required for a 90:10 OWR. Each of the test additives (additive comprising 1 mm EPS beads; Gilsonite™) was then added at various concentrations, followed by mixing for 10 minutes.

Initial rheology on the base fluid and electrical stability after addition of the test additives were recorded at 50° C. in accordance with API procedures. High pressure, high temperature (“HPHT”) fluid loss was conducted at 65° C., in accordance with API test procedures, with the addition of 10 kg/m³ of the additive (1 mm EPS beads) and Gilsonite™ in separate tests.

The properties of the base fluid are set out in Table 2:

TABLE 2

| | |
|---|---|
| Dial reading at rotor sped of 600 rpm (θ₆₀₀) | 22 |
| Dial reading at rotor speed of 300 rpm (θ₃₀₀) | 13 |
| Plastic velocity (mPa · s) | 10 |
| Yield point (Pa) | 2 |
| Electrical stability (V) | 940 |
| HPHT Fluid Loss (mL) | 12 |

Test results at 500 psi for 30 minutes on HPHT test cells showed the 10 kg/m³ addition of Gilsonite™ reduced the fluid loss to 8.0 cc/30 min. A second test performed with the base fluid and the addition of 10 kg/m³ of the additive (1 mm EPS beads) resulted in a fluid loss of 4.1 cc/30 min.

Permeability plugging tests (“PPTs”) are useful in predicting how a fluid can form a low permeable filter cake to plug porous formation and fractures, and are conducted using ceramic filtration discs of known permeability and porosity. PPTs were performed at 65° C. and 100° C., at 3000 psi through 3 D, 20 μm ceramic discs (OFI Testing Equipment, Inc., Houston, Tex.), with 10 kg/m³ loadings of test additives versus 10 kg/m³ loadings of Gilsonite™ in accordance with API RP 13i laboratory test procedures. Testing was performed with 200-250 mL of test fluid and the pressure was ramped up to 3100 psi prior to opening the valve stem and collecting filtrate. A top pressure of 100 psi was applied for a total pressure of 3000 psi exerted by the fluid on the filtration media.

Additional tests were conducted with the additive (1 mm EPS beads) using ceramic discs of 60 μm, 20 D; 90 μm, 100 D; and 150 μm, 180 D. PPTs were run at 65° C. and 100° C., 3000 psi and a total loading of 10 kg/m³ through the ceramic discs.

A mixture of conventional loss of circulation material (LCM) was then tested under the same conditions for use as a control and a total loading of 30 kg/m³. The LCM mixture contained 10 kg/m³ Gilsonite™, 6.67 kg/m³ calcium carbonate ‘0’, 6.67 kg/m³ Magma Fibre™, and 6.67 kg/m³ Fibre Fluid Med™.

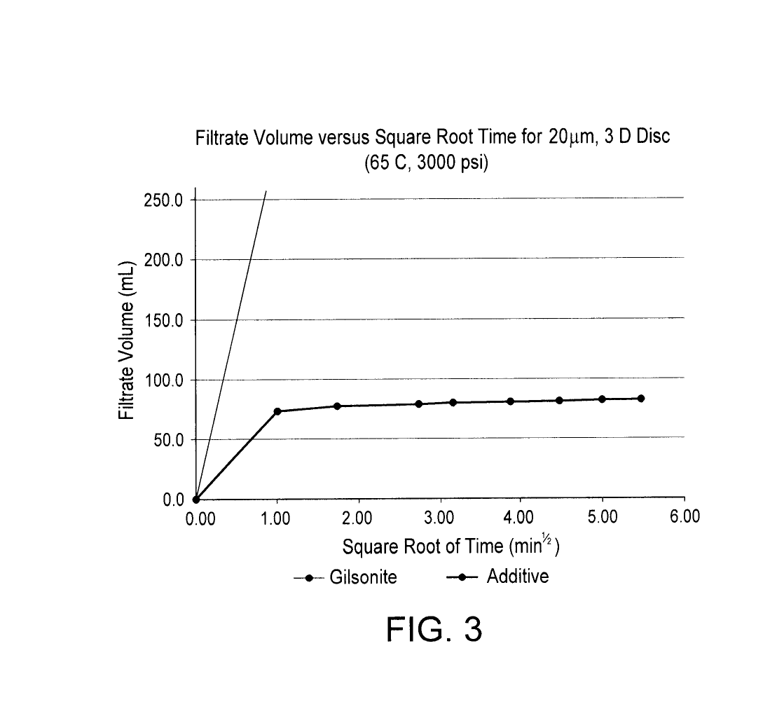

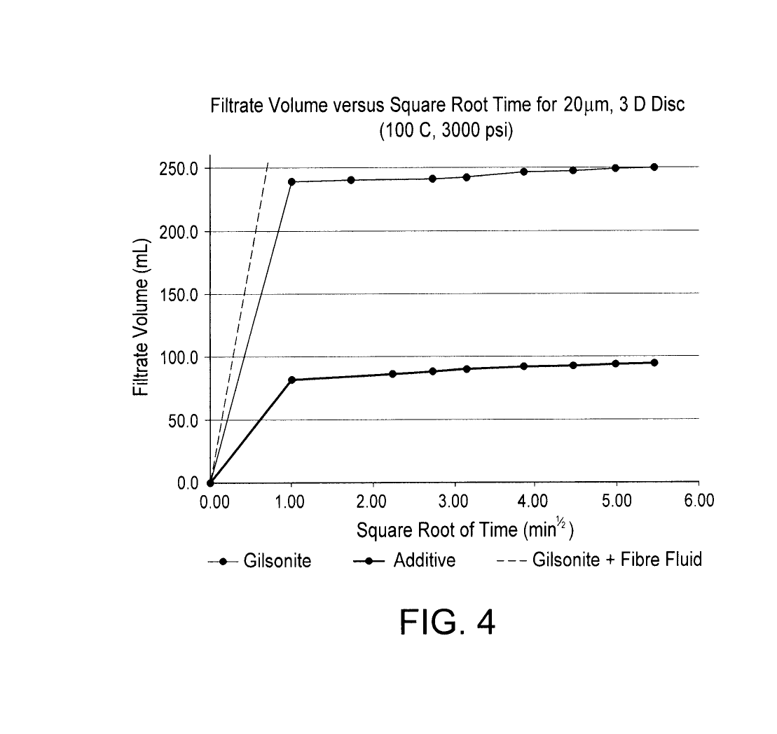

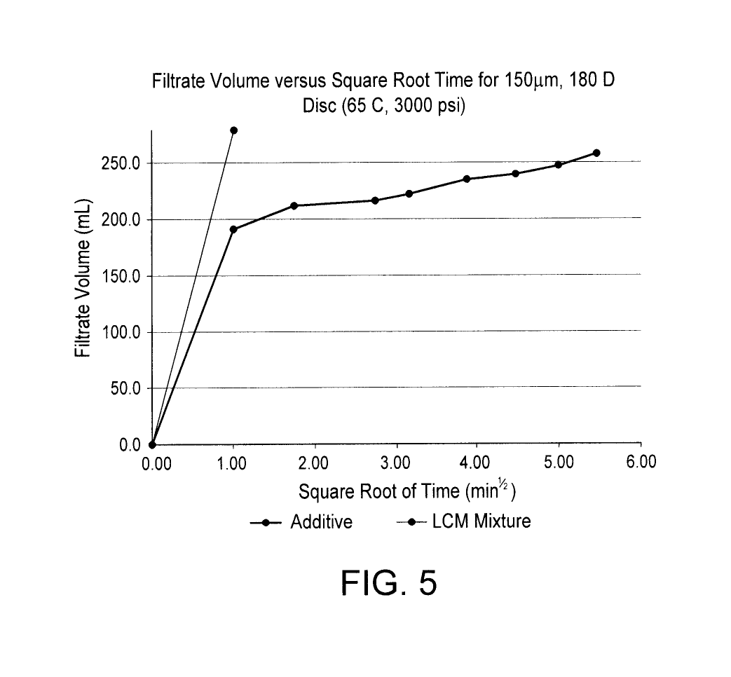

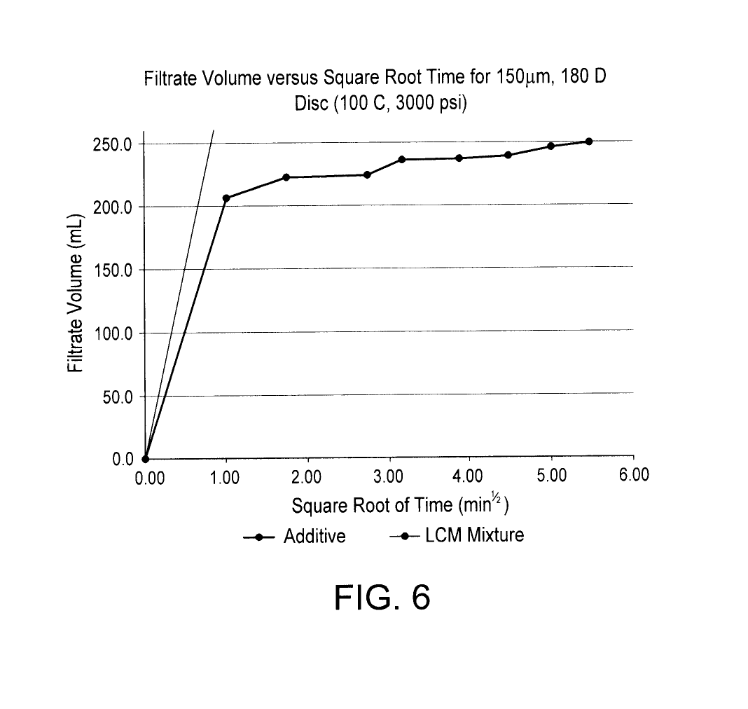

Data from PPTs through 20 μm, 3 D discs were plotted (FIGS. 3-6), and the total PPT volume and spurt loss were calculated (Tables 3-5).

TABLE 3
PPT Data, 20 μm, 3 D, 65° C., 3000 psi (10 kg/^{m3} loadings)

| | PPT Volume | Spurt Loss |
|---|---|---|
| Sample | (mL) | (mL) |
| Gilsonite ™ | >400 | >400 |
| Additive (1 mm EPS beads) | 83.3 | 75.7 |

TABLE 4
PPT Data, 20 μm, 3 D, 100° C., 3000 psi (10 kg/m³ loadings)

| | PPT Volume | Spurt Loss |
|---|---|---|
| Sample | (mL) | (mL) |
| Gilsonite ™ | 250 | 234 |
| Gilsonite ™ + 5 kg/m³ Fibre Fluid M ™ | >400 | >400 |
| Additive (1 mm EPS beads) | 124.6 | 104.2 |

TABLE 5
PPT Data, 150 μm, 180 D, 65° C., 3000 psi (30 kg/m³ loadings)

| | PPT Volume | Spurt Loss |
|---|---|---|
| Sample | (mL) | (mL) |
| Additive (1 mm EPS beads) | 258.8 | 174.0 |
| LCM mixture | >400 | >400 |

The PPT volume refers to the total PPT fluid loss. In the field, total fluid loss occurs when whole fluids are lost to porous or fractured formations during drilling operations. Spurt loss refers to the instantaneous volume of liquid that passes through a filter medium prior to deposition of a competent and controlling filter cake. The tests demonstrate that the additive (1 mm EPS beads) was more effective in decreasing total fluid loss and spurt loss compared to other products.

### Example 3

Expanded polystyrene beads (Elemix™, 0.5-1.0 mm beads, SYNTHEON Inc., Leetsdale, Pa.) were suspended in a viscosified fluid (water, polyanionic cellulose polymers, partially-hydrolyzed polyacrylamide/polyacrylate polymers, xanthan gum polymers, guar polymers, and bentonite clays) to yield a low density drilling fluid (densities ranging from about 350 kg/m³ to 995 kg/m³). Due to buoyancy conferred by the expanded polystyrene beads, the suspension floated above a screen filter (¼″) representing a loss zone.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

What is claimed is:

1. An additive for a drilling fluid used in a drilling operation to control lost circulation, the additive comprising polystyrene.

2. The additive of claim 1, wherein the polystyrene is in the form of particles.

3. The additive of claim 2, wherein the polystyrene comprises polystyrene particles, ground crystal polystyrene, or expanded polystyrene.

4. The additive of claim 3, wherein the polystyrene comprises expanded polystyrene having a specific gravity ranging from about 10 kg/m³ to about 350 kg/m³.

5. The additive of claim 1, further comprising a performance enhancer selected from a surface active agent, a surface tension reducer, or a wetting agent.

6. The additive of claim 5, wherein the polystyrene is blended or coated with the performance enhancer, or both.

7. The additive of claim 2, wherein the particles are similarly shaped or sized, or both.

8. The additive of claim 2, wherein the particles vary in shape or size, or both.

9. The additive of claim 2, wherein the particles range in size from about 1 micron to about 30,000 microns.

10. The additive of claim 2, wherein the particles range in size from about 100 microns to about 30,000 microns.

11. The additive of claim 2, wherein the particles range in size from about 500 to about 20,000 microns.

12. The additive of claim 2, wherein the particles range in size from about 1,000 microns to about 10,000 microns.

13. The additive of claim 2, wherein the particles range in size from about 1,000 microns to about 5,000 microns.

14. The additive of claim 2, wherein the particles range in size from about 400 microns to about 3,000 microns.

15. The additive of claim 2, wherein about 50% of the particles range in size from about 50 to about 500 microns, and 50% of the particles range in size from about 100 to about 1,000 microns.

16. The additive of claim 2, wherein about 33% of the particles range in size from about 200 to about 500 microns, about 33% of the particles range in size from about 1,000 to about 3,000 microns, and about 33% of the particles range in size from about 5,000 to about 30,000 microns.

17. The additive of claim 3, wherein the polystyrene particles have a size of at least about 45 microns.

18. The additive of claim 3, wherein the expanded polystyrene has a particle size of at least about 250 microns.

19. A drilling fluid comprising the additive of claim 1.

20. The fluid of claim 19, wherein the amount of the additive ranges from about 0.01 kg/m³ to about 500 kg/m³.

21. The fluid of claim 19, wherein the amount of the additive ranges from about 0.01 kg/m³ to about 200 kg/m³.

22. The fluid of claim 19, wherein the amount of the additive ranges from about 0.01 kg/m³ to about 100 kg/m³.

23. The fluid of claim 19, wherein the amount of the additive ranges from about 0.01 kg/m³ to about 50 kg/m³.

24. The fluid of claim 19, wherein the amount of the additive ranges from about 5 kg/m³ to about 20 kg/m³.

25. The fluid of claim 19, being formed from compressible expanded polystyrene and non-compressible fluid or partially compressible fluid.

26. The fluid of claim 25, wherein the polystyrene comprises expanded polystyrene having a specific gravity ranging from about 10 kg/m³ to about 350 kg/m³.

27. The fluid of claim 26, wherein the expanded polystyrene comprises particles ranging in size from about 0.5 mm to about 6.0 mm.

28. The fluid of claim 19, further comprising one or more lost circulation materials, liquid or solid lubricating agents, additive agents, inhibitors, or combinations thereof.

29. The fluid of claim 28, wherein the lost circulation materials comprise cellulose.

30. The fluid of claim 28, wherein the additive agents comprise viscosifiers, weighting agents, surface active agents, emulsifiers, oil wetters, alkalinity control additives, fluid loss reducers, thinners, dispersants, flocculants, and defoamers.

31. The fluid of claim 28, wherein the inhibitors comprise shale inhibitors, corrosion inhibitors, or anti-accretion agents.

32. The fluid of claim 19, further comprising one or more of a cross-linked polymer, mixed metal hydroxide, mixed metal oxide, bentonite, or bentonite-treated material.

33. A method of reducing or controlling lost circulation during a drilling operation comprising pumping the drilling fluid of claim 20 down hole during the drilling operation.

34. The method of claim 33, wherein the amount of the additive ranges from about 0.01 kg/m³ to about 500 kg/m³.

35. The method of claim 33, comprising adding the additive to a base fluid before mixing with the drilling fluid.

36. The method of claim 35, wherein the base fluid comprises an aqueous-based fluid exhibiting thixotropy.

37. The method of claim 36, wherein the aqueous-based fluid comprises one or more of a cross-linked polymer, mixed metal hydroxide, mixed metal oxide, bentonite, or bentonite-treated material.

38. The method of claim 33, wherein the additive is added to the drilling fluid before or during the drilling operation.

39. The method of claim 33, wherein the additive is heated above its glass transition temperature to flow and seal within a porous formation or fracture.

40. The method of claim 33, comprising adding a performance enhancer to the drilling fluid before, during, or after addition of the polystyrene to the drilling fluid.

41. The method of claim 33, further comprising conducting a down hole wash using a solvent.

42. The method of claim 41, wherein the solvent comprises an aromatic hydrocarbon or a chlorinated aliphatic hydrocarbon.

43. The method of claim 41, wherein the solvent is selected from benzene, toluene, xylene, ethylbenzene, methylene chloride, chloroform, carbon tetrachloride, diesel, d-limonene, pyridine, acetone, dioxane, dimethylformamide, methyl ethyl ketone, diisopropyl ketone, cyclohexanone, tetrahydrofuran, n-butyl phthalate, methyl phthalate, ethyl phthalate, tetrahydrofurfuryl alcohol, ethyl acetate, butyl acetate, 1-nitro-propane, carbon disulfide, tributyl phosphate, cyclohexane, methylcyclohexane, or ethylcyclohexane.

44. The method of claim 33, further comprising applying steam to heat the additive above its glass transition temperature for removal of the additive from within a porous formation or fracture.

45. The method of claim 33, further comprising recovering the additive from the drilling fluid using a screen or centrifuge.
